(19) United States
(12) Patent Application Publication
(10) Pub. No.: US 2010/0223899 A1
(43) Pub. Date: Sep. 9, 2010

(54) METHOD FOR ELIMINATING LEAF STALKS A HARVESTED CROP FLOW

(76) Inventors: Christophe R. Defurne, La Chapelle-Hermier (FR); Christine Nakas, Le Poire sur Vie (FR)

Correspondence Address: CNH AMERICA LLC, INTELLECTUAL PROPERTY LAW DEPARTMENT, PO BOX 1895, M.S. 641, NEW HOLLAND, PA, 17557, US

(21) Appl. No.: 12/452,972

(22) PCT Filed: Jul. 25, 2008
(86) PCT No.: PCT/EP2008/059810

§ 371 Date: Apr. 12, 2010

(51) Int. Cl. A01D 46/00; A23N 15/02; B65G 47/46

(52) U.S. Cl. 56/330; 460/134; 198/367

(57) ABSTRACT

The invention relates to a method of eliminating leaf stalks (P) from a harvested stream in a machine for harvesting fruit berries (G), said method successively comprising the steps of feeding the harvested stream to a sorting device through which a stream portion comprising leaf stalks (P) and fruit berries (G) can pass; recovering the portion passing through on a conveyor: removing from the conveyor components of the passing through portion other than leaf stalks (P); eliminating leaf stalks (P) remaining on the conveyor. The invention also relates to a sorting device, an extraction conveyor, and an elimination system for implementing this method, and a fruit berry harvesting machine including this kind of elimination system.

The invention relates to a method of eliminating petioles (leaf stalks) from a harvested stream in a machine for harvesting fruit berries, a sorting device, a extraction conveyor and an elimination system for implementing that method, and a machine for harvesting fruit berries including this kind of elimination system.

The invention applies to the field of mechanised harvesting of fruit growing on trees or bushes, such as grapes, berries, coffee berries, olives or other fruit in particular growing in bunches.

Such fruit is conventionally harvested by a shaker system that straddles a row of plants to detach the harvest. The harvested stream obtained is then conveyed into the machine to be stored in at least one hopper provided for this purpose or in an attached trailer.

However, because of the action of the shaker system, the harvested stream includes, in addition to detached fruit, and among other things, juice, leaves, wood particles, bunches of fruit of various sizes.

To eliminate components other than fruit, in particular leaves and wood particles, harvesting machines include a cleaning system which is adapted to eliminate said components from the stream by suction before it is stored.

Harvesting machines can also carry a sorting device which in particular separates the harvested stream as a function of the size of the components of said stream. Thus by providing such sorting before cleaning, it is possible to suck up only portions containing large components, in particular to avoid sucking up detached fruits.

Moreover, the search for quality in vinification requires the elimination of leaf stalks contained in the harvested stream. However, it is not possible to carry out such elimination in the harvesting machine during cleaning or during sorting.

This is because suction cleaning is based on the difference between the lifts of the components of the stream and sorting is based on the difference between the sizes said components. Now, in the case of leaf stalks, their lift and their size are not sufficiently different from those of fruit berries to be able to clean or sort one without the other, without losing a large number of said berries.

The invention aims to improve on the prior art, in particular by proposing a method of eliminating leaf stalks from a harvested stream, said method being implemented in the harvest machine while recovering the detached berries.

To this end, a first aspect of the invention proposes a method of eliminating leaf stalks from a harvested stream in a machine for harvesting fruit berries, said method successively comprising the steps of:
feeding the harvested stream to a sorting device through which a stream portion comprising leaf stalks and fruit berries can pass;
recovering the portion passing through on a conveyor:
removing from the conveyor components of the passing through portion other than leaf stalks;
eliminating leaf stalks remaining on the conveyor.

A second aspect of the invention proposes a sorting device for implementing the above elimination method, said sorting device comprising at least two transverse sorter bars to which a cyclic relative movement is imparted, said movement being adapted to allow longitudinal movement of the stream over said bars by opening passages between them, said passages being adapted to allow detached berries and leaf stalks to drop under said sorting device.

A third aspect of the invention proposes an extraction conveyor for implementing the said elimination method, said conveyor comprising a belt driven in a longitudinal direction between an upstream roller and a downstream roller, said conveyor further comprising at least one deflector disposed above said belt, said deflector being adapted to remove from the belt components other than leaf stalks.

A fourth aspect of the invention proposes a system for eliminating leaf stalks comprising the said sorting device and the said extraction conveyor disposed under said sorting device.

A fifth aspect of the invention proposes a machine for harvesting fruit berries comprising a motorised support structure and a harvesting system mounted on said structure, said harvesting system being adapted to detach the harvest, said machine comprising the said elimination system which is fed with a harvested stream coming from the harvesting system.

Other objects and advantages of the invention will emerge in the course of the following description, which is given by way of example, with reference to the accompanying figures, in which:

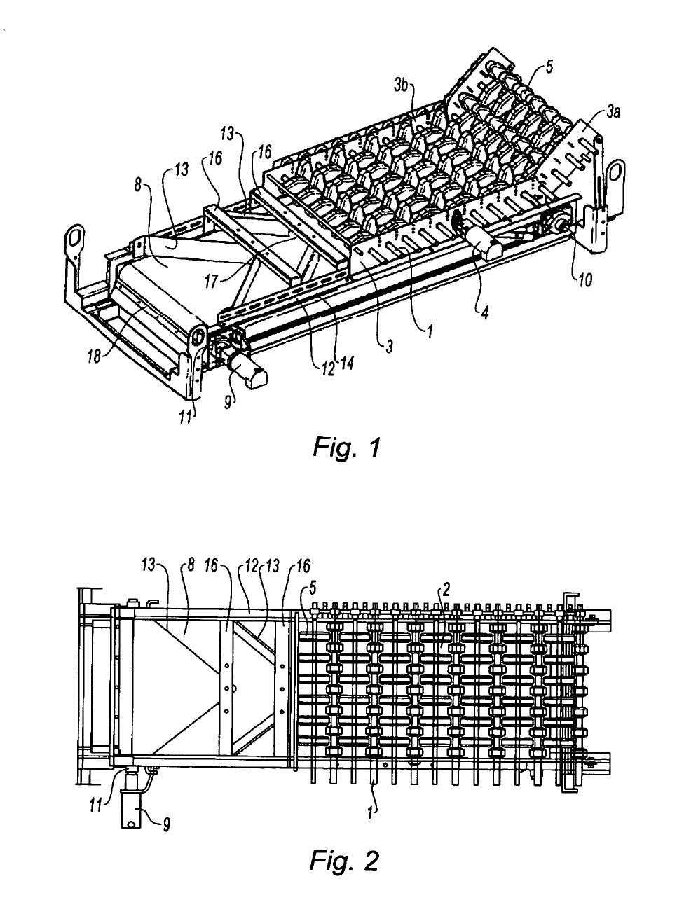

FIG. 1 is a perspective view of one embodiment of a system of the invention for eliminating leaf stalks;

FIG. 2 is a top view of the elimination system shown in FIG. 1;

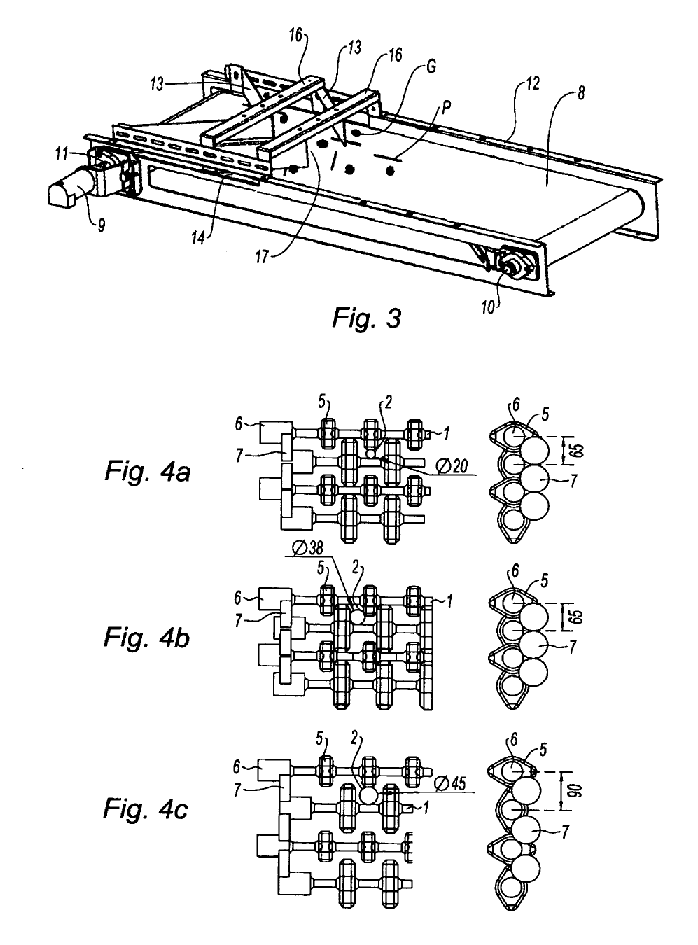

FIG. 3 is a perspective view of the extraction conveyor used in the elimination system shown in FIGS. 1 and 2;

FIG. 4 shows sorter bars of the sorting device used in the elimination system shown in FIGS. 1 and 2, from above and in side view, driven in rotation, respectively in a position with a nominal distance between centres (FIG. 4a), in a transversely offset position (FIG. 4b), and in a position with an increased distance between centres (FIG. 4c).

The invention relates to a machine for harvesting berries, in particular a grape harvester for mechanised harvesting of grapes, notably for subsequent vinification thereof. A harvester conventionally includes a motorised support structure that is equipped with a driver station and a harvesting system mounted on said structure.

The harvester is designed to straddle at least one row of vines in order, as it moves, to introduce the vine stems successively into the harvesting system, which is adapted to detach the harvest. To this end, the harvesting system includes vine shakers, in particular a series of shakers provided on either side of the space into which the vine stems are introduced.

The harvester also includes a system for continuous recovery of the detached harvest, which includes, in addition to detached grapes, and among other things, juice, leaves, wood particles, bunches of various sizes. In one embodiment, the system includes two bucket conveyors adapted to recover the detached crop under the introduction space and to convey said crop into the upper portion of the harvester.

In the context of vinification of grapes, it is desirable to eliminate leaf stalks P contained in the harvested stream. To this end, there is described hereinafter a system for eliminating leaf stalks P that is adapted to be mounted in the machine to be fed with a harvested stream from the harvesting system. The elimination system can be fed directly with the stream from the harvesting system. Alternatively, it can be fed via a cleaning system and/or a sorting device.

The elimination system includes a sorting device through which a portion of the stream including leaf stalks P and detached fruit berries G is likely to pass. The elimination system also includes, under said sorting device, an extraction conveyor that is adapted to recover on the conveyor the portion passing through and to remove from said conveyor components of the portion passing through other than leaf stalks P. Thus by thereafter eliminating leaf stalks P that remain on the conveyor, the system eliminates leaf stalks P from the harvested stream, recovering in particular detached grapes G.

There is described hereinafter, with reference to the figures, an embodiment of a sorting device adapted to eliminate leaf stalks P. The device is adapted to sort the harvested stream into two layers as a function of the size of the components of said stream. The upper layer containing in particular bunches of fruit is conveyed on the sorting device and the bottom layer containing in particular detached berries G and leaf stalks P passes through said device.

The sorting device includes at least two transverse sorter bars 1, specifically 14 sorter bars 1 in the figures, to which a cyclic relative movement is imparted. The movement is adapted to move the stream longitudinally on said bars by opening passages 2 between them. Moreover, the passages 2 are adapted to enable detached berries G and leaf stalks P to drop under said sorting device. Thus detached berries G and leaf stalks P can be recovered on the extraction conveyor.

As they come into contact with the crop stream, the sorter bars 1 are preferably made from a corrosion-resistant material, in particular a stainless metal or a synthetic material.

In the embodiment described, the sorter bars 1 are mounted on a frame 3 and conjointly driven in rotation about a transverse axis, a motor 4 being associated with the frame for this purpose. The frame 3 also has a downstream part 3a that can be inclined relative to an upstream part 3b, in particular by producing a frame 3 in two parts that are pivotably articulated about a transverse axis. Thus by modifying the inclination it is possible to obtain more benefit from gravity at the end of the movement of the stream over the sorter bars 1, such that sorting is improved.

Furthermore, the stream conveyed on the sorter bars 1, which primarily includes bunches of fruit of various sizes, can be ejected at the end of its movement into a storage hopper provided beyond the downstream part 3a. Alternatively, the search for quality in vinification requiring destemming (debunching) of the grape stream, the stream conveyed on the sorter bars 1 can be fed to a device for separating grapes attached to stalks. Moreover, to facilitate recovery of the ejected stream, the downstream end of the sorting device can extend beyond the extraction conveyor.

The bars 1 carry members 5 whose exterior envelope is not a circle about their rotation axis. Moreover, the members 5 of two adjacent sorter bars 1 are disposed to cooperate to displace the stream longitudinally on said bars while opening passages 2 between them.

To be more precise, the members 5 of a sorter bar 1 are offset angularly and transversely relative to the members 5 of the adjacent bar 1 to form longitudinal passages 2 between a member 5 and the adjacent bar 1 or transverse passages between two adjacent members 5 of a respective bar 1.

As shown in the figures, the geometry of the envelope of the members 5 is inscribed in an ellipse so as to have a radial dimension that is greater than a perpendicular radial dimension. Moreover, the members 5 of two adjacent bars 1 are offset angularly by 90° and transversely by a step greater than the transverse dimension of the members 1. Thus the configuration represented is obtained using a distance between centres of the bars 1 that is greater than half the greater radial dimension of the members 5. Furthermore, in this configuration, alternate sorter bars are disposed transversely in exactly the same manner.

The sorter bars 1 obtained in this way are particularly effective for agitating the harvested stream to be sorted. This is because, as they rotate, the geometry of the members 5 causes a succession of accelerations in various directions.

In the figures, the sorter bars 1 are uniformly distributed on the frame 3. However, the distance between centres of the sorter bars 1 and/or their respective transverse positions can be adjustable in order to modify the geometry of the passages 2. Furthermore, as a function of the characteristics of the stream to be separated, the geometry of the passages 2 can be different as a function of the longitudinal position of the sorter bars on the frame 3.

Modifying the distance between centres and the transverse position of four sorter bars 1 the ends of which carry a gear 6, two adjacent gears 6 meshing in rotation via a common drive gear 7, is described with reference to FIG. 4.

In FIG. 4a, the disposition of the sorter bars 1 is with a nominal distance between centres of 65 mm and with a member 5 positioned in the middle of the free space between two successive members 5 of the adjacent bar 1. In this configuration, longitudinal passages 2 are formed between a member 5 and the adjacent bar 1, the passages having a diameter of 20 mm.

In FIG. 4b, alternate sorter bars 1 have been moved transversely to offset the member 5 into the free space between two successive members 5 of the adjacent bar 1. To enable meshing in this offset position, the gears 6 have a transverse dimension sufficient to retain their contact with the drive gear 7. In this configuration, longitudinal and transverse passages 2 are formed between two adjacent members 5 of a respective bar, the passages having a diameter of 38 mm.

In FIG. 4c, the distance between centres of the sorter bars 1 is increased to 90 mm to form longitudinal passages 2 with a diameter of 45 mm. Of course, this configuration can be combined with transverse displacement of the sorter bars 1.

There is described hereinafter, in particular with reference to FIG. 3, an embodiment of the extraction conveyor including a belt 8 driven by a motor 9 in a longitudinal direction between an upstream roller 10 and a downstream roller 11. The rollers 10, 11 are mounted on a structure 12 associated with the frame 3 of the sorting device, the structure 12 also enabling the assembly of the elimination system into the harvesting machine.

The sorter device is stacked on the conveyor so that the crop portion passing through drops onto the belt 8 and is conveyed by it. Furthermore, the sorting device and the conveyor are mounted one on the other for parallel movement in opposite directions.

The extraction conveyor further includes at least one deflector 13, which may be made out of sheet metal and which is disposed above the belt 8, said deflector being adapted for removing from the belt 8 components other than leaf stalks (petioles) P, in particular grapes G.

Each deflector 13 is disposed downstream of the area in which berries G and leaf stalks P are received onto the belt 8. To this end, the sorting device is mounted in vertical alignment with the upstream area of the belt 8, the downstream area of said belt being equipped with the deflectors 13 and not receiving crop from the sorting device.

The embodiment shown proposes to extract components other than leaf stalks P by making use of the height of said components on the belt 8, said extraction being effected by lateral ejection. Indeed, the leaf stalks P lie flat on the belt 8 and therefore have a height greatly less than that of the grapes G.

To effect this ejection, the deflector 13 is inclined outwardly and rearwardly between the transverse and longitudinal directions, for instance at an angle of 45°, being oriented toward the upstream roller 10. Moreover, the deflector 13 is spaced vertically from the belt 8 by a height sufficient to intercept components other than leaf stalks P. Furthermore, the deflector 13 has a length sufficient to eject said components laterally, off the belt 8.

Although the leaf stalks P are relatively sticky because they have been wetted by the grape juice, the material of the belt 8, in particular the surface which receives the crop portion passing through the sorter device, can be chosen to improve the retention of the leaf stalks P on it. Thus even during ejection of the components other than the leaf stalks P, the latter components are not liable to entrain the leaf stalks P with them. In particular, the material of the belt 8 can be impermeable and relatively soft. Furthermore, the upper surface of the belt 8 can have a grained or similar surface finish.

In one embodiment the conveyor includes at least one set of deflectors 13 adapted to eject components other than leaf stalks P to a respective side of the belt 8. In particular, as shown, the deflectors 13 can be disposed in a V-shape oriented toward the upstream roller 10, each deflector 13 forming one branch of the V-shape.

In the embodiment shown, two sets of deflectors 13 are disposed longitudinally above the belt 8, each deflector 13 of a set being aligned transversely and associated with an edge of the structure 12. Moreover, the structure 12 includes lateral openings 14 for ejecting components intercepted by the deflector 13. Those components include in particular grapes G, which are recovered near the openings 14, either by a conveyor or directly into a crop storage hopper.

Furthermore, the deflectors 13 are held in position relative to the belt 8 by associated cross-members 16 on either side of the structure 12. In particular, a cross-member 16 is provided for each set of deflectors 13, the upper edges of the deflectors 13 of the set being affixed to a cross-member 16.

The sets of deflectors 13 extract components other than the leaf stalks P in two successive steps, each step ejecting components disposed laterally relative to the components ejected in the next step. Thus, ejection is progressive, in particular in order to limit the risks of blocking the lateral openings 14 and of entraining the leaf stalks P as a result of ejecting too many components at a time.

To this end, the upstream set of deflectors 13 has a central opening 17 and the downstream set of deflectors 13 transversely covers substantially all of the belt 8. Alternatively, a plurality of sets of deflectors 13 can be provided with openings of decreasing size in the conveying direction of the belt, to intercept these components in more than two steps.

Also, the elimination system represented includes a scraper 18, in particular produced in a semi-rigid synthetic material, that is associated with the structure 12 to rub on the upper surface of the belt 8 in the vicinity of the downstream roller 11, to eliminate leaf stalks P on said belt.

1. A method of eliminating leaf stalks (P) from a harvested stream in a machine for harvesting fruit berries (G), said method comprising the steps of:
feeding the harvested stream to a sorting device through which a stream portion including leaf stalks (P) and fruit berries (G) can pass;
recovering the stream portion passing through the sorting device on a conveyor;
removing from the conveyor components of the passing through portion other than leaf stalks (P); and
eliminating leaf stalks (P) remaining on the conveyor.

2. An elimination method according to claim 1, wherein the extraction of components of the portion passing through other than leaf stalks (P) is effected by making use of the height of said components on the conveyor.

3. An elimination method according to claim 1, wherein the extraction of components of the portion passing through other than leaf stalks (P) is effected by lateral ejection.

4. An elimination method according to claim 3, wherein the extraction of components of the portion passing through other than leaf stalks (P) is effected in successive steps, each step ejecting components disposed laterally relative to components ejected in the next step.

5. A sorting device comprising at least two transverse sorter bars (1) to which a cyclic relative movement is imparted, said movement being adapted to allow longitudinal movement of the stream over said bars while opening passages (2) between them, said passages being adapted to allow detached berries (G) and leaf stalks (P) to drop under said sorting device, wherein the sorting device is configured to perform the steps of:
feeding the harvested stream to a sorting device through which a stream portion including leaf stalks (P) and fruit berries (G) can pass;
recovering the stream portion passing through the sorting device on a conveyor;
removing from the conveyor components of the passing through portion other than leaf stalks (P); and
eliminating leaf stalks (P) remaining on the conveyor.

6. A sorting device according to claim 5, wherein the sorter bars (1) are driven in rotation about a transverse axis, said bars carrying members (5) the exterior envelopes of which are not circular circle about their rotation axes, the members (5) of two adjacent sorter bars (1) being disposed to cooperate to move the stream longitudinally on said bars by opening passages (2) between them.

7. A sorting device according to claim 6, wherein the members (5) of a bar (1) are offset angularly and transversely relative to the members (5) of the adjacent bar (1).

8. A sorting device according to claim 7, wherein the passages (2) are formed longitudinally between a member (5) and the adjacent bar (1) and/or transversely between two adjacent members (5) of a respective bar (1).

9. A sorting device according to claim 8, wherein the geometry of the exterior envelope of the members (5) is inscribed in an ellipse, the members (5) of two adjacent bars (1) being offset angularly by 90° and transversely by a step greater than the transverse dimension of the members (5).

10. A sorting device according to claim 5, wherein the distance between centres of the sorter bars (1) can be adjusted in order to modify the geometry of the passages (2).

11. A sorting device according to claim 5, wherein the respective transverse positions of the sorter bars (1) can be adjusted in order to modify the geometry of the passages (2).

12. A sorting device according to claim 5, wherein the sorter bars (1) are mounted on a frame (3) having a downstream part (3a) that can be inclined relative to an upstream part (3b).

13. An extraction conveyor comprising a belt (8) driven in a longitudinal direction between an upstream roller (10) and a downstream roller (11), said conveyor further comprising at least one deflector (13) disposed above said belt, said deflector being adapted to remove from the belt (8) components other than leaf stalks (P), wherein the extraction conveyor is configured to perform the steps of:
feeding the harvested stream to a sorting device through which a stream portion including leaf stalks (P) and fruit berries (G) can pass;
recovering the stream portion passing through the sorting device on a conveyor;
removing from the conveyor components of the passing through portion other than leaf stalks (P); and
eliminating leaf stalks (P) remaining on the conveyor.

14. An extraction conveyor according to claim 13, wherein the deflector (13) is inclined between the transverse and longitudinal directions, said deflector being spaced from the belt (8) by a height sufficient to intercept components other than leaf stalks (P) and having a length sufficient to eject said components laterally.

15. An extraction conveyor according to claim 14, further including at least one set of deflectors (13), said deflectors being adapted to eject components other than leaf stalks (P) from a respective side of the belt (8).

16. An extraction conveyor according to claim 15, further including at least two sets of deflectors (13) distributed longitudinally on the belt (8), the upstream set having a central opening (17) and the downstream set covering transversely substantially all the belt (8).

17. An extraction conveyor according to claim 14, wherein the rollers (10, 11) of the belt (8) are mounted on a structure (12) having lateral openings (14) for ejecting components intercepted by the deflector (13).

18. A system for eliminating leaf stalks comprising a sorting device and an extraction conveyor disposed under said sorting device, wherein the sorting device includes at least two transverse sorter bars (1) to which a cyclic relative movement is imparted, said movement being adapted to allow longitudinal movement of the stream over said bars while opening passages (2) between them, said passages being adapted to allow detached berries (G) and leaf stalks (P) to drop under said sorting device, wherein the extraction conveyor includes a belt (8) driven in a longitudinal direction between an upstream roller (10) and a downstream roller (11), said conveyor further comprising at least one deflector (13) disposed above said belt, said deflector being adapted to remove from the belt (8) components other than leaf stalks (P), further wherein at least one of the sorting device and the extraction conveyor are configured to perform the steps of:
feeding the harvested stream to a sorting device through which a stream portion including leaf stalks (P) and fruit berries (G) can pass;
recovering the stream portion passing through the sorting device on a conveyor;
removing from the conveyor components of the passing through portion other than leaf stalks (P); and
eliminating leaf stalks (P) remaining on the conveyor.

19. An eliminating system according to claim 18, wherein the sorting device and the extraction conveyor have parallel opposite conveyor directions.

20. An eliminating system according to claim 18, further including a scraper (18) rubbing on the upper surface of the belt (8) in the vicinity of the downstream roller (11) to eliminate leaf stalks (P) on said belt.

21. A machine for harvesting fruit berries comprising:
a motorised support structure and a harvesting system mounted on said structure, said harvesting system being adapted to detach the harvest, said machine comprising an elimination system, which is fed with a harvested stream coming from the harvesting system, wherein the elimination system includes at least a sorting device and a extraction conveyor, wherein the sorting device includes at least two transverse sorter bars (1) to which a cyclic relative movement is imparted, said movement being adapted to allow longitudinal movement of the stream over said bars while opening passages (2) between them, said passages being adapted to allow detached berries (G) and leaf stalks (P) to drop under said sorting device, wherein the extraction conveyor includes a belt (8) driven in a longitudinal direction between an upstream roller (10) and a downstream roller (11), said conveyor further comprising at least one deflector (13) disposed above said belt, said deflector being adapted to remove from the belt (8) components other than leaf stalks (P), further wherein at least one of the sorting device and the extraction conveyor are configured to perform the steps of:
feeding the harvested stream to a sorting device through which a stream portion including leaf stalks (P) and fruit berries (G) can pass;
recovering the stream portion passing through the sorting device on a conveyor;
removing from the conveyor components of the passing through portion other than leaf stalks (P); and
eliminating leaf stalks (P) remaining on the conveyor.
